(19) United States
(12) Patent Application Publication
(10) Pub. No.: US 2006/0282661 A1
(43) Pub. Date: Dec. 14, 2006

(54) System and method of providing certified document retrieval

(76) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(21) Appl. No.: 11/152,943

(22) Filed: Jun. 13, 2005

(51) Int. Cl. H04L 9/00; H04K 1/00

(52) U.S. Cl. 713/156; 713/175; 713/173; 713/186; 713/183

(57) ABSTRACT

A method of providing a certified digital copy of a certified document for display on a requesting party mobile terminal display screen is provided. The method includes retrieving the certified digital copy from a repository, sending the certified digital copy to the requesting party mobile terminal as unsaveable displayable information for immediate display on the requesting party terminal display screen, wherein the unsaveable displayable information cannot be stored at the terminal, sending an electronic certification associated with the certified digital copy certifying the authenticity of the digital copy.

### BACKGROUND OF THE INVENTION

This invention relates to a method and apparatus for certified digital copies of certified documents.

While the invention is particularly directed to the art of wireless telecommunications system, and will be thus described with specific reference thereto, it will be appreciated that the invention may have usefulness in other fields and applications.

Today a wide range of important documents are used by people in everyday activities. These documents can be referred to as certified documents in that they certify, as authentic, information about the person to which they pertain.

Some of these documents are carried by people because they may be needed frequently. Examples of these documents can include driver's licenses which are used to prove a person may operate a motor vehicle, as well as offer proof of the person's identity and other information such as their age. However, carrying these documents can lead to misplacing them which can be quite inconvenient when they are needed.

Some of these documents are only needed infrequently. Examples of these documents can include birth certificates used to show proof of identity and date of birth, or a baptismal certificate used to show proof of reception of a sacrament and religious affiliation. The infrequent use of these documents can lead to a person misplacing them by forgetting where they are kept.

For these reasons, it would be convenient and more secure if these important documents could be retrieved in real-time from the actual certified source such as the State Agency or County Agency or Religious Organization whose job it is to process and file these important documents. The present invention contemplates a new and improved method and system that resolves the above-referenced difficulties and others.

### SUMMARY OF THE INVENTION

A method and system for providing certified digital copies of certified documents are provided.

In one aspect of the invention the method includes retrieving a certified digital copy of a certified document from a repository, sending the certified digital copy to a requesting party mobile terminal as unsaveable displayable information for immediate display on the requesting party terminal display screen, and sending an electronic certification associated with the certified digital copy certifying the authenticity of the digital copy to the requesting party mobile terminal.

In accordance with another aspect of the invention, the system includes means for retrieving the certified digital copy of the certified document from a repository, means for sending the certified digital copy to a requesting party mobile terminal as unsaveable displayable information for immediate display on the requesting party terminal display screen, and means for sending an electronic certification associated with the certified digital copy certifying the authenticity of the digital copy to the requesting party mobile terminal.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating the system for providing certified digital copies of certified documents in accordance with the invention; and

FIG. 2 is a flow chart illustrating the method for providing certified digital copies of certified documents in accordance with the invention.

### DETAILED DESCRIPTION OF THE PREFERRED EMBODIMENTS

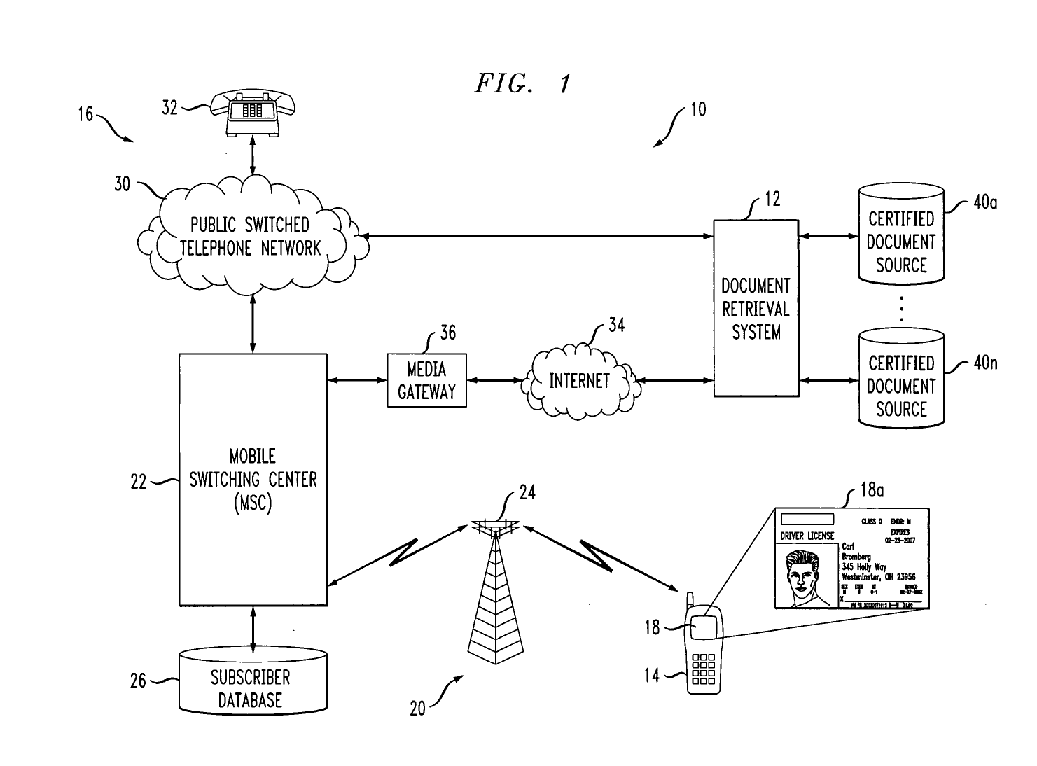

Referring to FIG. 1 a block diagram of a system for providing a certified digital copy of a certified document is illustrated generally at 10. The system 10 includes a certified digital document retrieval system 12 connected to a requesting party mobile terminal 14 via a telecommunications system 16. The requesting party mobile terminal 14 can also be referred to as a cellular phone, a mobile phone or mobile handset. The mobile terminal 14 includes a display screen 18 for displaying an image of a certified digital copy of a document shown in greater detail at 18a, as shall be described in further detail below.

The telecommunications system 16 includes portions of a wireless telecommunications system 20 which enable voice and data communications to the mobile terminal 14. The wireless telecommunications system 20 includes a switching center, such as a Mobile Switching Center (MSC) 22, connected to the mobile terminal 14 via a base station 24. The MSC 22 handles call setups and call routing to and from the mobile terminal 14 in a known manner.

The wireless telecommunications network 20 also includes a subscriber database 26. The subscriber database 26 can be disposed at the MSC 22, or on other nodes in the wireless network 20. The subscriber database 26 can include individual subscriber records, current status of subscribers, and information on call routing and billing. The subscriber database 26 can also include a list of the features which a subscriber subscribes to and can be used to determine whether a subscriber is authorized to use the certified digital document retrieval system as described herein.

The telecommunications system 16 also includes portions of the Public Switched Telecommunications Network 30 for connecting other terminals 32 with the mobile terminal 14 for communication therewith. These terminals 32 can include landline terminals or other mobile terminals.

The certified digital document retrieval system 12 is connected to the telecommunications system 16 for sending certified digital copies of documents, in the form of image data as shall be described in detail below. The certified digital document retrieval system 12 can include a computing device, such as a server, and the software processes needed to perform the functional tasks as described herein. The certified digital document retrieval system 12 is connected to the MSC 22 via the Internet 34 using a packet data network connection. A media gateway 36 can be used to interface the MSC with the Internet in a known manner.

The certified digital document retrieval system 12 is connected to a plurality of certified document sources 40a through 40n via network connections suitable for transferring image data from the sources to the document retrieval system. The certified document sources are official sources of certified digital copies, recognized as storing digital copies of certified documents. These official certified repositories 40a-40n can be operated by federal, state and county governmental agencies, religious agencies, hospitals, universities, etc. responsible for issuing and storing the corresponding original important documents. These important documents are referred to herein as certified documents because they certify that the information they contain is authentic as pertaining to the person or persons for which they correspond. Examples of these certified documents can include, but are not limited to drivers licenses, birth certificates, death certificates, marriage licenses, religious records, business licenses, liquor licenses, college diplomas, college transcripts, among others.

The certified repositories 40a-40n include digital copies of the certified documents stored in databases and are associated with the person or persons to which they pertain in a known manner. The digital copies are stored as image information which can be displayed on a display, such as the mobile terminal display 18, so as to visually represent a true, accurate copy of the certified document to which they correspond.

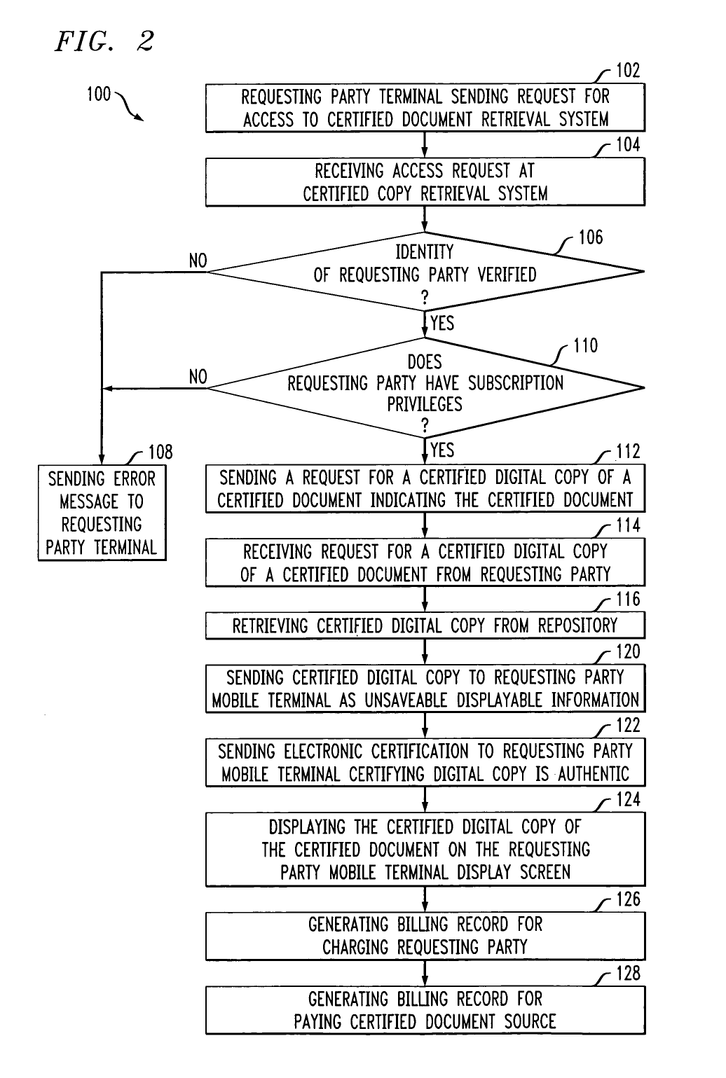

Referring now to FIG. 2, a method of providing a certified digital copy of a certified document is illustrated generally at 100. The method 100 includes a certified digital document retrieval system 12 receiving an access request from a requesting party at 102. The access request can be made via the telecommunications network 16. For example, the requesting party dials a phone number to create a call session connecting the requesting party mobile terminal 14 to the certified document retrieval system 12. The MSC 22 routes the call to the certified document retrieval system which receives the request for access from the requesting party 104 via the PSTN 30.

The certified digital document retrieval system 12 verifies the identity of the requesting party at 106. The requesting party's identity can be determined in any suitable known manner. For example, the certified document retrieval system 12 can prompt the requesting party to enter a password via their mobile terminal 14. The certified document retrieval system 12 verifies the requesting party's identity upon receiving the correct password from the requesting party. Alternatively, the requesting party can send a voice print to the certified document retrieval system 12 by speaking a word or phase into their mobile terminal 14. The certified document retrieval system 12 then verifies the requesting party's identity using the spoken voice print in a known manner.

If the identity of the requesting party cannot be verified at 106, the certified document retrieval system 12 sends an error message to the requesting party mobile terminal at 108 via the telecommunications system 16 indicating that they cannot access the certified document retrieval system. This error message can be an automated voice message, an SMS message or other suitable message sent to the mobile terminal 14 via the wireless network 20 in a known manner.

Upon verifying the identity of the requesting party at 106, the certified document retrieval system can determine if the requesting party has subscription privileges for accessing the certified document retrieval system and retrieving digital copies of certified documents at 110. The certified document retrieval system 12 can access the wireless network subscriber database 26 sending a suitable command via the MSC 22 to determine if the requesting party has subscription privileges. Alternatively, the certified document retrieval system 12 can include a subscription list of subscribers having subscription privileges and can check this list since the subscriber's identity has been verified. This step of determining whether the requesting party has subscription privileges at 110 can be considered as optional if so desired.

The requesting party then chooses the type of certified document for which they want to receive the certified digital copy, sending the request for the certified digital copy of the certified document to the certified digital document retrieval system at 112 via the telecommunications network 16. Examples of these certified documents are provided above. The certified document retrieval system receives the request indicating the certified document at 114.

The method also includes the certified digital document retrieval system 12 retrieving the certified digital copy of the certified document at 116 requested by the requesting party at 112. The certified digital document retrieval system retrieves the digital copy from the appropriate certified document repository 40a-40n via a data network connection. This connection can be a secure connection to prevent unauthorized use.

The method 100 also includes sending the certified digital copy to the requesting party mobile terminal at 120. The certified digital copy can be sent from the certified digital document retrieval system 12 to the mobile terminal 14 via the network connection, such as a secure network connection to the MSC 22 which sends it to the mobile terminal via a servicing base station 24. The certified digital copy is sent to the mobile terminal as unsaveable displayable information suitable for immediately displaying the image of the certified document on the display screen 18 of the requesting party mobile terminal as shown in greater detail at 18a. The unsaveable displayable information is displayed on the mobile terminal display screen but it cannot be saved at the mobile terminal.

The method 100 also includes the certified digital document retrieval system 12 sending an electronic certification associated with the digital copy of the certified document certifying the authenticity of the certified document and that the digital copy is authentic, being a true copy of the certified document. For example, if the certified document is a driver's license, the electronic certification certifies that the digital copy is a true copy of the driver's license and that the driver's license is authentic. The electronic certification can encrypt the certified digital document information sent at 120 in such a manner that only the requesting party can display the certified digital document. This can be accomplished in a known manner such as encrypting it using a key that only the requesting party has.

The method 100 also includes displaying the certified digital copy of the certified document on the requesting party mobile terminal display screen at 124 for presenting the certified document to others as proof that the requesting party possesses the certified document. For example, the requesting party can obtain the certified digital copy of the certified document as described above, display it on their mobile terminal display screen 18 and show the image to a store clerk to show proof of age when purchasing an alcoholic beverage.

The method 100 also includes generating a billing record for charging the requesting party an access fee for accessing the certified digital copy of a certified document at 126. The certified digital document retrieval system 12 sends the billing information needed for generating the billing record, including an identifier identifying the requesting party and identifying the type of certified document the requesting party received to a network element in the wireless network, such as the MSC, that is responsible for billing subscribers. The access fee can be a flat fee that is the same for every certified copy retrieved. Alternatively, the access fee can vary and can be determined based on the type of certified document for which the certified digital copy was received by the requesting party. For example, the requesting party can be charged five dollars for receiving a digital copy of a birth certificate and charged fifty cents for receiving a digital copy of a driver's license.

The method 100 also includes generating a billing record for paying the certified document source 40 for providing the certified digital copy of the certified document to the certified document retrieval system 12. In this manner, the certified document source can receive revenue for storing, maintaining and providing the certified digital copies.

As described herein, the mobile telecommunications network is tied into federal, state, county, and religious agencies that are repositories for important documents referred to herein as certified documents. These certified documents can be accessed by parties requesting and receiving access after the parties prove their identity. The mobile telecommunications network is used to request the digital copy of the certified document which is sent to the requesting party's mobile terminal for immediate display as displayable but unsaveable image information. An electronic certification is also sent with the digital copy certifying the authenticity of the certified document and that the digital copy is an authentic copy of the certified document. The digital copy image information is displayed on the display screen of the mobile terminal so that the requesting party presents the display of the certified document to others as proof that the requesting party has possession of the certified document. The displayable unsaveable image information can be displayed on the mobile terminal display screen but it cannot be stored at the mobile terminal. After the requesting party is done presenting the document, the displayed certified copy is erased from the display screen, such as by pressing a button on the mobile terminal or closing the mobile terminal, among other ways. Further, the displayable information can include a timing feature which only allows the certified copy to be displayed for a preset length of time. These aspects prevent the certified digital copy from being stolen and used by others.

The system and method of providing certified digital copies of the certified documents reduces or eliminates the chances of the requesting party losing the important certified document and there would be less likelihood of the document falling into the wrong hands so that an identity theft could possibly take place.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of providing a certified digital copy of a certified document for display on a requesting party mobile terminal display screen comprising:
receiving a request for access to a certified digital document retrieval system from a requesting party;
verifying the identity of the requesting party;
receiving a request for a certified digital copy of a certified document from the requesting party;
retrieving the certified digital copy from a repository;
sending the certified digital copy to the requesting party mobile terminal as unsaveable displayable information for immediate display on the requesting party terminal display screen, wherein the unsaveable displayable information cannot be stored at the terminal; and
sending an electronic certification associated with the certified digital copy certifying the authenticity of the digital copy to the requesting party mobile terminal.

2. The method defined in claim 1 wherein the step of verifying the identity of the requesting party further comprises receiving a correct password from the requesting party terminal.

3. The method defined in claim 1 wherein the step of verifying the identity of the requesting party further comprises;
receiving a requesting party voice print from the requesting party terminal; and
authenticating the voice print as belonging to the requesting party.

4. The method defined in claim 1 further comprising determining that the requesting party has subscription privileges for accessing the certified digital document retrieval system.

5. The method defined in claim 4 wherein the step of determining that the requesting party has subscription privileges includes consulting a wireless communications network subscriber database.

6. The method defined in claim 1 wherein the repository is an official certified repository recognized as providing certified digital copies of corresponding certified documents.

7. The method defined in claim 6 wherein the repository is a database.

8. The method defined in claim 1 wherein the electronic certification is an electronic signature.

9. The method defined in claim 1 further comprising:
generating a billing record for an access fee charged for receiving the digital copy; and
associating the billing record with the requesting party for billing the requesting party for receiving the digital copy.

10. The method defined in claim 9 wherein the step of generating the billing record for the access fee comprises determining the amount of the access fee based on the type of the certified document for which the certified digital copy was requested.

11. The method defined in claim 1 further comprising an operator of the certified digital copy retrieval system paying an operator of the repository for receiving the digital copy from the repository.

12. A method of presenting a certified digital copy of a certified document using a wireless mobile terminal, the method comprising:
a requesting party sending a request for access from a requesting party mobile terminal to a certified digital document retrieval system via a wireless communications network, the requesting party mobile terminal having a display screen;
providing verification of the requesting party's identity to the certified digital document retrieval system via the requesting party mobile terminal;
the requesting party sending a request for the certified digital copy of the certified document to the document retrieval system;
receiving the requested certified digital copy of the certified document as unsaveable displayable information for immediate display on the requesting party terminal display screen, wherein the unsaveable displayable information cannot be stored at the terminal;
receiving an electronic certification associated with the certified digital copy certifying the authenticity of the digital copy; and
displaying the certified digital copy on the requesting party terminal display screen for presentation.

13. The method defined in claim 12 wherein the step of providing verification of the identity of the requesting party further comprises sending a correct password from the requesting party terminal.

14. The method defined in claim 12 wherein the step of providing verification of the identity of the requesting party further comprises transmitting a voice print of the requesting party from the requesting party terminal.

15. The method defined in claim 12 wherein the electronic certification is a number and electronic signature.

16. The method defined in claim 12 further comprising:
the requesting party being billed for receiving the digital copy.

17. The method defined in claim 16 wherein the step of the requesting party being billed comprises requesting party being billed for an amount based on the type of the certified document for which the certified digital copy was requested.

18. A system for providing a certified digital copy of a certified document for display on a mobile terminal, the system comprising:
means for receiving a request for access to a certified digital document retrieval system from a requesting party;
means for verifying the identity of the requesting party;
means for receiving a request for a certified digital copy of a certified document from the requesting party;
means for retrieving the certified digital copy from a repository;
means for sending the certified digital copy to the requesting party mobile terminal as unsaveable displayable information for immediate display on the requesting party terminal display screen, wherein the unsaveable displayable information cannot be stored at the terminal; and
means for sending an electronic certification associated with the certified digital copy certifying the authenticity of the digital copy to the requesting party mobile terminal.

19. The system defined in claim 18 further comprising means for billing the requesting party an access fee based on the type of certified document for which the certified digital copy was requested.

20. The system defined in claim 18 wherein the repository is a certified document repository recognized as providing certified digital copies of corresponding certified documents.
